(19) United States
(12) Patent Application Publication
(10) Pub. No.: US 2003/0160587 A1
(43) Pub. Date: Aug. 28, 2003

(54) AC motor used wirelessly and charged with DC

(76) Inventor: Jia-Hua Fan, Guan-Nan Village (TW)

Correspondence Address: PRO-TECHTOR INTERNATIONAL, 20775 Norada Court, Saratoga, CA, 95070-3018, US

(21) Appl. No.: 10/085,205

(22) Filed: Feb. 26, 2002

(51) Int. Cl. H02P 1/24; H02P 1/42; H02P 3/18; H02P 5/28; H02P 7/36

(52) U.S. Cl. 318/727

(57) ABSTRACT

The present invention relates to an AC motor used wirelessly and charged with DC; and especially refers to an AC motor that can be charged with AC and store electricity in the CD battery, thereby upgrade the efficiency of motors. When the present invention is incorporated into the electric appliances, such as vacuum cleaners and mowers, users can move their electric appliances around. No power cord is needed any more and, therefore, the present invention is a practical design for electric appliance users.

### BACKGROUND OF THE INVENTION

1. Field of the Invention

The present invention relates to an AC motor used wirelessly and charged with DC; and is designed to facilitate the wireless use of AC motor that is charged by DC battery and is, therefore, a convenient design for electric appliances, such as vacuum cleaners and mowers.

2. Description of the Prior Art

The present invention relates to an AC motor used wirelessly and charged with DC; and especially refers to an AC motor that transmits AC and is provided with a CD battery to store electricity.

### SUMMARY OF THE INVENTION

As a result of technological advancement and upgrade of living standard, people depend more and more on the electric appliances, such as vacuum cleaners and mowers. People move around constantly when they use their electric appliances. All electric appliances are connected to receptacles through cords. The cords inconvenience the use of electric appliances. Take the vacuum cleaners for example, users need to pull out the plug from the receptacle in one room before they clean another room; then they plug again to use the vacuum cleaners. The disadvantage is obvious. Take the mowers as another example, most people use their mowers in the yard and have to purchase extended cords in order to supply power to mowers from their houses. Apparently, the power cords are another problem for the electric appliance users.

The inventor of present invention had studied these problems thoroughly and hopes that the present invention can solve these problems permanently.

The present invention will be apparent in its contents of technique after reading the detailed description of the preferred embodiments of the present invention in reference to the accompanying drawings, wherein:

### BRIEF DESCRIPTION OF THE DRAWINGS

FIG. 1 is a perspective view showing the circuit structure of present invention.

### DETAILED DESCRIPTION OF THE PREFERRED EMBODIMENT

The inventor hereby illustrates the structure and functions of the AC motor used wirelessly and charged with DC together with the accompanied drawing as follows:

The inventor hereby states that the inventor has been granted ROC patent No. 152821 for the invention named “Power transformer converting DC into AC”. The present invention incorporates the concepts of the invention numbered 152821 of ROC patent.

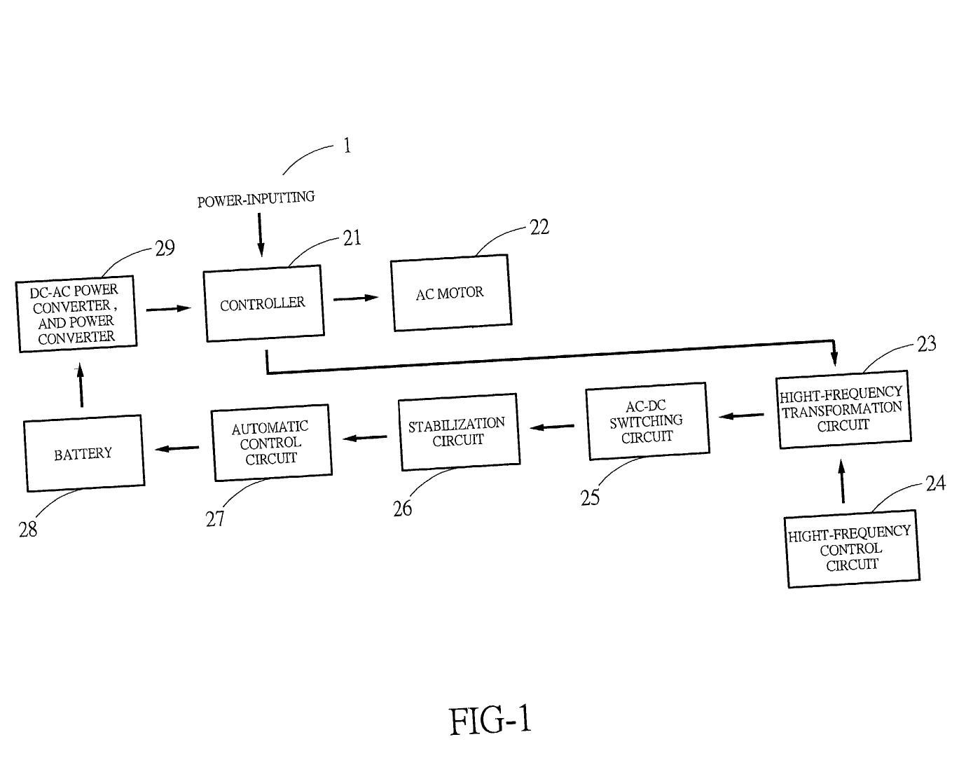

The conventional motor is merely provided with a power-inputting that activates the motor. As shown by FIG. 1, the present invention is provided with a power-inputting 1, controller 21, AC motor 22, high-frequency transformation circuit 23, high-frequency control circuit 24, AC-DC switching circuit 25, stabilization circuit 26, automatic control circuit 27, battery 28, DC-AC power converter, and power converter 29.

The power-inputting 1 means the power cord that connects to the receptacle for power supply;

The controller 21 means a switch that allows users to choose either power-inputting 1 or CD-AC power converter 29 as the source of power for AC motor 22;

AC motor 22 means a conventional motor;

High-frequency transformation circuit 23 and high-frequency control circuit 24 control and adjust the voltage to the required level by high-frequency method;

AC-DC switch circuit 25 converts the AC transmitted by power-inputting 1 into DC;

Stabilization circuit 26 stabilizes the DC that has been adjusted;

Automatic control circuit 27 stores the DC in the battery 28;

DC-AC power converter 29 adjusts the DC stored in the battery 28 into AC, thereby allows users to switch the controller 21 in order to supply power to the AC motor 22.

To use AC via cords, users can switch the power supply of the controller 21 to power-inputting 1; and thus transmit AC from receptacle to the AC motor 22.

To supply power wirelessly via battery 28, users need to charge the battery 28 fully and switch the power-inputting of controller 21 toDC-AC power converter 29; then the power of the battery 28 will be converted into AC and transmitted to the AC motor 22. With the present invention, users no longer need to plug cords in the receptacle and AC motor 22; and can use and move their electric appliances conveniently. The present invention is a perfect accessory for using electric appliances outdoor.

As stated in the preceding paragraphs, the present invention is valuable industrially and a breakthrough for the accessories of electric appliances, such as vacuum cleaners and mowers. The design of present invention has never been publicized in any archives and markets and complies with the requirements of progressiveness and practicability.

Having thus described my invention, what the inventor claims as new and desire to be secured by Letters Patent of the United States are:

1. An AC motor used wirelessly and charged with DC is provided with a power-inputting, controller, AC motor, high-frequency transformation circuit, high-frequency control circuit, AC-DC switching circuit, stabilization circuit, automatic control circuit, battery, DC-AC power converter, and power converter. Of which:
the power-inputting means the power cord that connects to the receptacle for power supply;
the controller means a switch that allows users to choose either power-inputting or CD-AC power converter as the source of power for AC motor;
AC motor means a conventional motor;
high-frequency transformation circuit and high-frequency control circuit control and adjust the voltage to the required level by high-frequency method;
AC-DC switch circuit converts the AC transmitted by power-inputting into DC;
stabilization circuit stabilizes the DC that has been adjusted;
Automatic control circuit stores the DC in the battery;
and DC-AC power converter adjusts the DC stored in the battery into AC, thereby allows users to switch the controller in order to supply power to the AC motor.

2. An AC motor used wirelessly and charged with DC as stated in claim 1, the present invention is designed for the electric appliances such as vacuum cleaners and mowers.
